(19) United States
(12) Patent Application Publication
(10) Pub. No.: US 2025/0122015 A1
(43) Pub. Date: Apr. 17, 2025

(54) TOUCHLESS SYSTEM FOR DISPENSING PRODUCT SAMPLES

(71) Applicant: Outform Ltd., Moshav Magshimim (IL)

(72) Inventor: Ariel Haroush, North Miami, FL (US)

(73) Assignee: Outform Ltd., Moshav Magshimim (IL)

(21) Appl. No.: 18/988,867

(22) Filed: Dec. 19, 2024

Related U.S. Application Data
(63) Continuation of application No. 17/537,187, filed on Nov. 29, 2021.
(60) Provisional application No. 63/242,299, filed on Sep. 9, 2021.
(60) Provisional application No. 63/120,239, filed on Dec. 2, 2020.

(51) Int. Cl. B65G 1/06; B65D 83/04

(52) U.S. Cl. CPC B65G 1/06; B65D 83/0409

(57) ABSTRACT

A system is disclosed for dispensing a product sample to a consumer that includes a storage compartment for holding a plurality of spherical pods each containing a product sample in a closely-packed assemblage, a dispensing area communicating with the storage compartment and including an access port accessible by a consumer to obtain a single spherical pod, a dispensing wheel mounted for rotation adjacent the dispensing area for transferring a single spherical pod from the storage compartment to the access port, and an agitator wheel mounted for movement within the storage compartment to agitate the spherical pods within the storage compartment so as to reduce friction between adjacent spherical pods in the closely-packed assemblage and promote movement of pods from the storage compartment towards the dispensing wheel.

### CROSS-REFERENCE TO RELATED APPLICATION

The subject application is a continuation of U.S. patent application Ser. No. 17/537,187, which was filed on Nov. 29, 2021, which claims the benefit of priority to U.S. Provisional Patent Application Ser. No. 63/242,299, which was filed on Sep. 9, 2021, and U.S. Provisional Patent Application Ser. No. 63/120,239, which was filed on Dec. 2, 2020, the contents of which are incorporated by reference herein in their entireties.

### BACKGROUND OF THE INVENTION

### 1. Field of the Invention

The subject invention is directed to a dispensing machine, and more particularly, to a system and method for dispensing product samples to a consumer without requiring physical contact of the dispending machine and the consumer.

### 2. Description of Related Art

Mechanical coin-operated dispensing machines have been around for many years. A coin is inserted in a slot, the coin is verified to determine size and weight and then an item from the machine is released or the coin is added to a total, which, when reached releases the goods. A problem with such machines is that only a certain class of low-priced goods can be sold through such machines, since the use of coins limits the amounts that can reasonably be charged.

The problem may be solved by allowing paper money. However, paper money requires elaborate electronic recognition systems, which can easily fail when banknotes are dirty or creased. A further solution is to allow credit cards, but not all people have credit cards. People under the age of 18 for example could not use such machines.

Another problem with coin-operated machines is that coin blanks, which are the same size and weight as the coin but have not been minted as coins, work in the machine. Furthermore, there have been cases where National Mints have used the same blanks to make coins of different denominations for different countries, with the result that the lower valued coin was used in place of the higher valued coin to successfully fool coin-operated machines.

A further problem with dispensing machines is that they are built specifically for the goods that they dispense. There is very little flexibility in the type of goods that can be included in the machine, and even a fairly small change of price may often require reprogramming at the machine. An additional problem, irrespective of the machine being for coins or credit cards or banknotes, is that the machine requires contacting specific surfaces by users, something which is a particular issue with COVID-19 and other diseases that may be passed on by touch.

Marketers have also encountered problems during the distribution of samples, and sample giveaways that have yet to be solved. Sample distribution programs have to be staffed to prevent people from taking multiple items at once. The need to staff a kiosk also creates a limitation on hours and locations that the sample kiosk can operate.

A further problem for marketers is allowing potential consumers to try their products so that they are more inclined to purchase them. The marketer wants to know the details of the potential purchaser. Potential purchasers on the other hand, while happy to try the goods, are reluctant to provide details and often provide false details. Furthermore, marketers and vendors have no way of knowing whether a person has already tried the goods so that samples can be concentrated on potential new customers.

Thus a clear need exists for sample distribution kiosks and vending machines to have improved handling, interaction, flexibility, and vending capabilities. The subject invention provides a novel solution to all of these problems and concerns.

### SUMMARY OF THE DISCLOSURE

The subject invention is directed to a new and useful system for dispensing a product sample to a consumer in a touchless manner. The system includes a storage compartment for holding a plurality of product sample containing spherical pods in a closely-packed assemblage, a dispensing area communicating with the storage compartment and including an access port accessible by a consumer to obtain a single spherical pod, a dispensing wheel mounted for rotation partially within the storage compartment and partially within the dispensing area for transferring a single spherical pod from the storage compartment to the access port; an agitator mounted for movement within the storage compartment to agitate the spherical pods within the storage compartment so as to reduce friction between adjacent spherical pods in the closely-packed assemblage and promote movement of pods from the storage compartment towards the dispensing wheel.

The system can also include a ramped guide path providing communication between the storage compartment and the dispensing area, wherein the guide path is sloped towards the dispensing wheel. The dispensing wheel can be mounted for rotation about an axis extending perpendicular to the guide path. The dispensing wheel can be mounted for rotation in a clock-wise direction.

The dispensing wheel can have a generally circular configuration and include a plurality of circumferentially spaced apart pockets, each pocket being shaped for receiving a spherical pod delivered from the ramped guide path to the access port. The dispensing wheel can have a sensing means associated with the plurality of circumferentially spaced apart pockets for detecting reception of a spherical pod within said pocket. The dispensing wheel can include a plurality of indentations, wherein each indentation is shaped and sized to fit one spherical pod at a time.

The agitator can be mounted for rotation about an axis extending perpendicular to the guide path. The agitator can have a generally elliptical configuration. The agitator can be mounted for rotation in a clock-wise direction and a counter-clockwise direction.

The system can also include a first motor for rotating the dispensing wheel and a second motor for rotating the agitator. A motor controller can be used controlling the first and second motors. The system can also include a means for enabling a consumer to interact with the motor controller in a contact-less manner, using a mobile terminal image processor by way of an image, to enable a transfer of a spherical pod from the storage compartment to the access port in order to collect the spherical pod from the access port to receive a product sample.

A depth of the storage compartment can be less than twice a length of a diameter of the spherical pod. The storage compartment can include a vertically oriented divider partially bisecting the storage compartment.

A method of dispensing a product sample to a consumer is also disclosed. The method includes providing a plurality of spherical pods each containing a product sample in a closely-packed assemblage within a storage compartment of an enclosure, agitating the spherical pods within the storage compartment of the enclosure so as to reduce friction between adjacent spherical pods in the closely-packed assemblage and thereby promoting movement of the spherical pods from the storage compartment towards a dispensing area, rotating a dispensing wheel adjacent the dispensing area to transfer a single spherical pod from the storage compartment to the access port, dispensing a spherical pod to a consumer from an access port communicating with the dispensing area.

The method can include agitating the spherical pods in the storage compartment of the enclosure involves rotating an agitator mechanism within the storage compartment. Agitating can include rotating the agitator mechanism less than 360 degrees in a clockwise direction and rotating the agitator mechanism less than 360 degrees in a counter-clockwise direction. The agitator rotation can be activated by a signal from a server external to the enclosure. A message can be sent from a user mobile terminal used for scanning a visual code on an outside of the enclosure to prompt the signal for activating rotation to be sent.

These and other features of the system and method of the subject invention will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those skilled in the art will readily understand how to make and use the touchless sample dispensing system of the subject invention without undue experimentation, preferred embodiments thereof will be described in detail herein below with reference to the figures wherein:

FIG. 1 is an illustration of the touchless sample dispensing system or machine of the subject invention in a typical commercial environment, wherein a consumer uses a mobile device to interact with the system in a touchless manner by way of an externally located image containing a code;

FIG. 2 is an illustration of the interior of the enclosure of the sample dispensing system shown in FIG. 1;

FIG. 3 is an enlarged localized view taken from FIG. 2, showing the manner in which maintenance personal use a smart device to interact with the system in a touchless manner by way of an internally located image containing a code;

FIGS. 4 and 5 illustrate interactive smart device screens for performing maintenance on the system;

FIGS. 6 through 11 illustrate interactive smart device screens that enable a consumer to collect a product sample from the system in a touchless manner

FIG. 6 depicts a user scanning the external code with a camera of a mobile device;

FIG. 7 depicts a display of the mobile device after scanning the external code;

FIG. 8 depicts the display of the mobile device showing a self-identification process;

FIG. 9 depicts the display of the mobile device showing another self-identification process;

FIG. 10 depicts the display of the mobile device showing a second step in the self-identification process;

FIG. 11 depicts the display of the mobile device showing a promotion of the device;

FIG. 12 is a schematic diagram of the data flow interface for the system of the sample dispending system of the subject invention;

FIG. 13 is an elevation view of the interior of the dispensing system shown in FIG. 1, illustrating the interior storage compartment holding a plurality of spherical pods each containing a product sample in a closely-packed assemblage and the dispensing area for transferring a single spherical pod from the storage compartment to the access port shown in FIG. 1;

FIG. 14 is an exploded perspective view of the interior of the dispensing system shown in FIG. 1, with parts separated for ease of illustration;

FIGS. 15 through 17 illustrate the clockwise-rotational movement of the dispensing wheel as it transfers a single spherical pod from the storage compartment to the access port;

FIGS. 18 through 27 illustrate the clockwise and counter-clockwise movements of the agitator wheel mounted within the storage compartment to agitate the spherical pods within the storage compartment;

FIG. 28 is a perspective view of a two-piece spherical pod, separated to show a product sample contained therein, wherein the pod is preferably made from a bio-degradable material; and

FIG. 29 is a perspective view of an alternate embodiment of the dispensing system of the subject invention, wherein products associated with the samples are displayed on shelves below the sample access port.

### DETAILED DESCRIPTION OF THE PREFERRED EMBODIMENTS

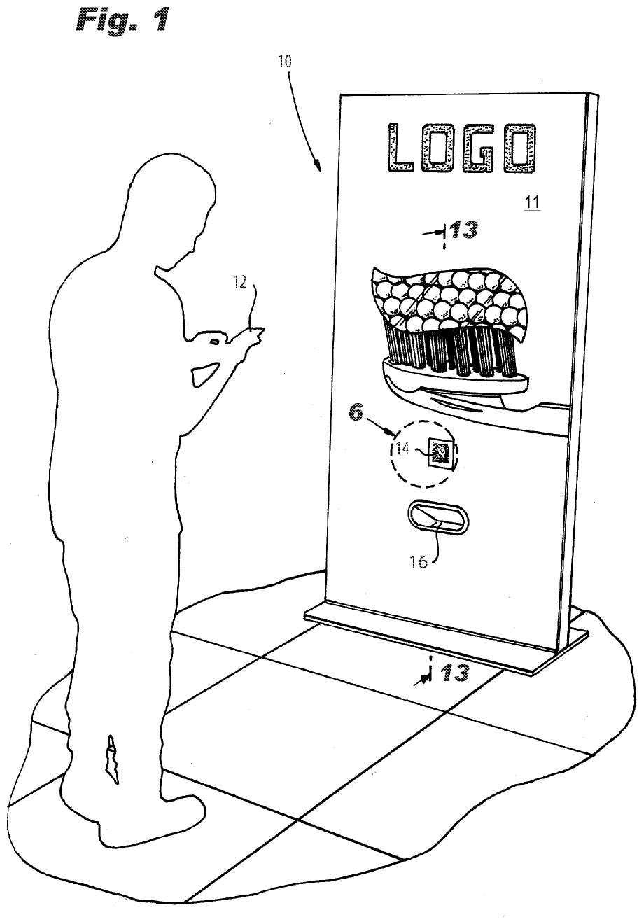

Referring now to the drawings wherein like reference numerals identify similar aspects of the subject invention, there is illustrated in FIG. 1 a contact-less system 10 for dispensing a product sample to a consumer or other user of the subject invention in a typical commercial environment, wherein a consumer uses a camera enabled smart device (e.g., a smart phone or similar portable electronic device) 12 to interact with the system 10 in a touchless manner by way of an externally located code 14, such as QR code or a SKU located on a front surface of the system 10 adjacent an access port 16, where the samples are retrieved.

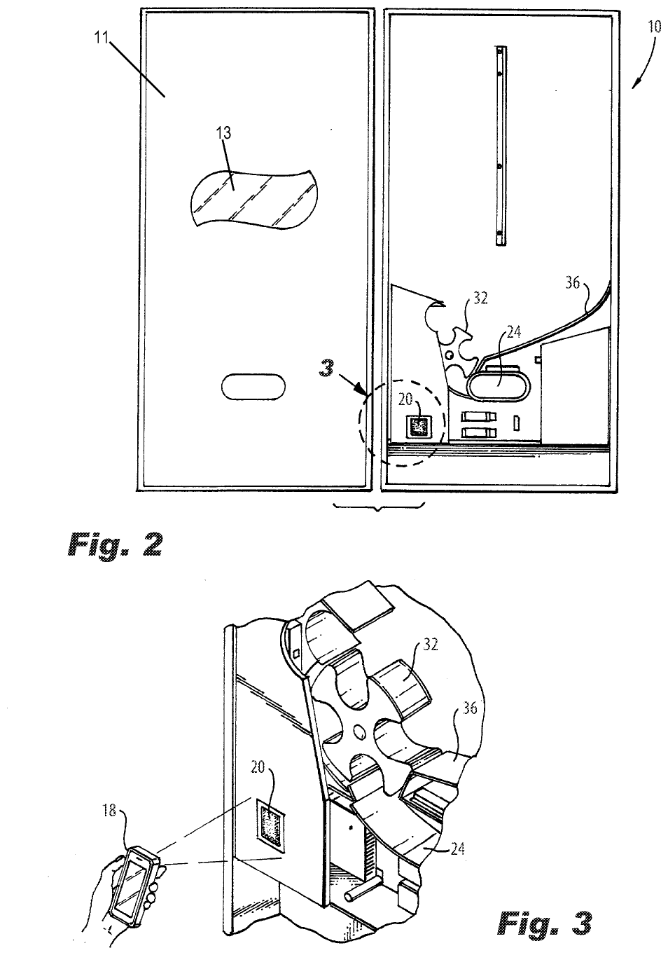

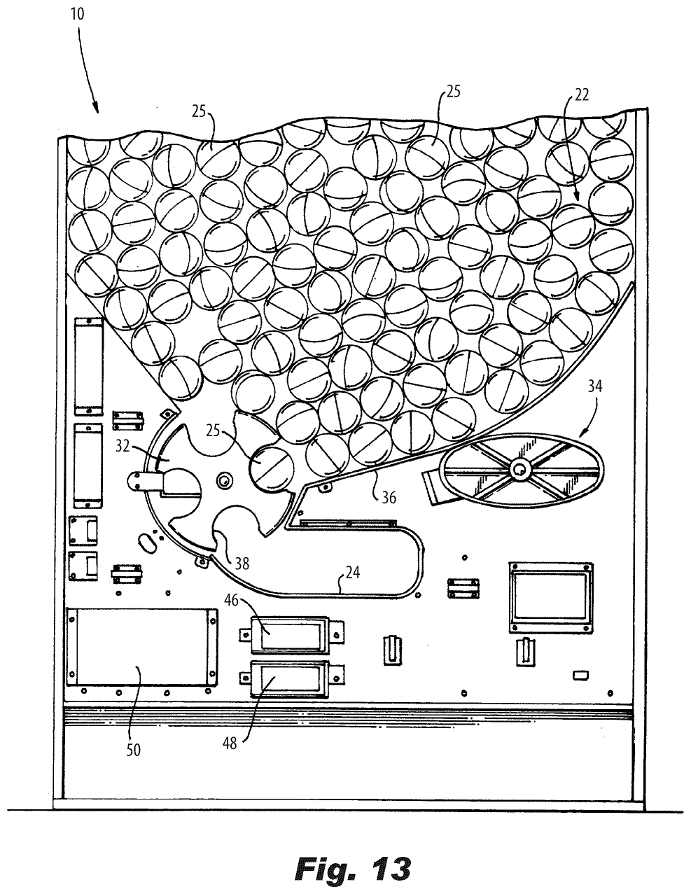

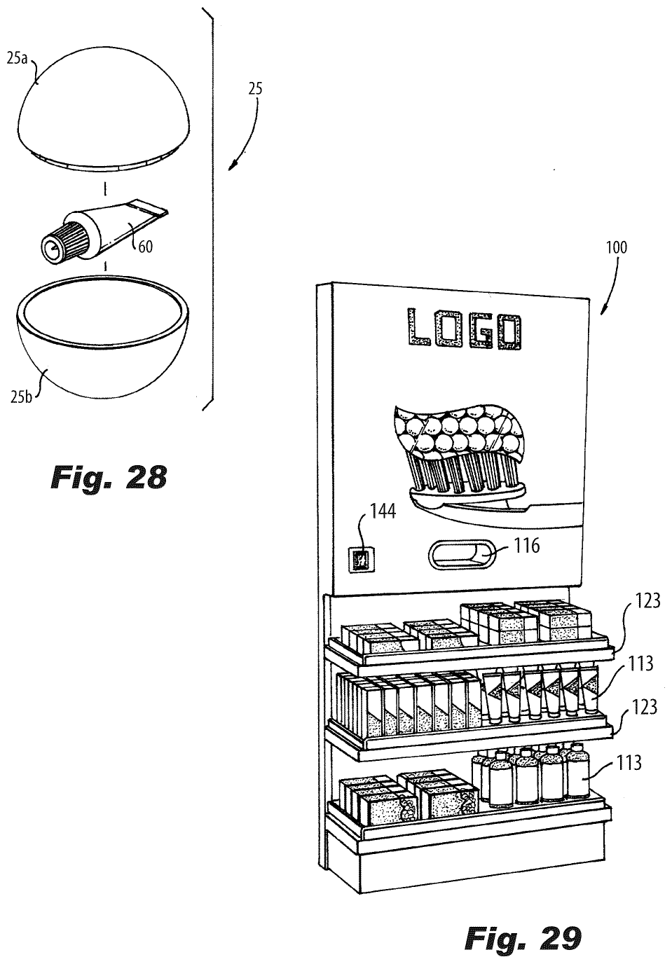

FIG. 2 is an illustration of the interior of the sample dispensing system 10 shown in FIG. 1, with the localized view of FIG. 3 showing the manner in which maintenance personal use a mobile device 18 to interact with the system 10 in a touchless manner by way of an internally located QR code 20. The interior of the dispensing system 10 includes a storage compartment 22 for holding a plurality spherical pods (shown in detail in FIG. 28), each of which includes a product sample to be dispensed to a user or shopper a closely-packed assemblage. The dispensing system 10 also includes a dispensing area 24 communicating with the storage compartment 22 which includes an access port 16 accessible by a consumer to obtain a single spherical pod and a dispensing wheel 32 which rotates to trap and move single spherical pod at a time from the storage compartment 22 to the access port 16. An agitator wheel 34 (shown in FIG. 13) is also rotatably mounted for movement within the storage compartment to agitate the spherical pods within the storage compartment 22. As the pods are agitated static friction between certain adjacent spherical pods is eliminated and the pods are free to roll down the ramp 36 into one of the pockets of the dispensing wheel. FIG. 2 further shows a divider 13 that partially divides the storage compartment 22. The divider 13 is vertical and only extends partially down the middle of the compartment providing structural support to the dispensing system, and connecting the front and pack panels of the storage compartment.

FIG. 3 shows a user's mobile device 18 being used to scan the QR code 20 located on the front of the system 10. A successful scan and interaction with the system results in the dispensing wheel 32 turning and moving one pod, per scan, from the ramp 36 to the access port 16 for the user to retrieve.

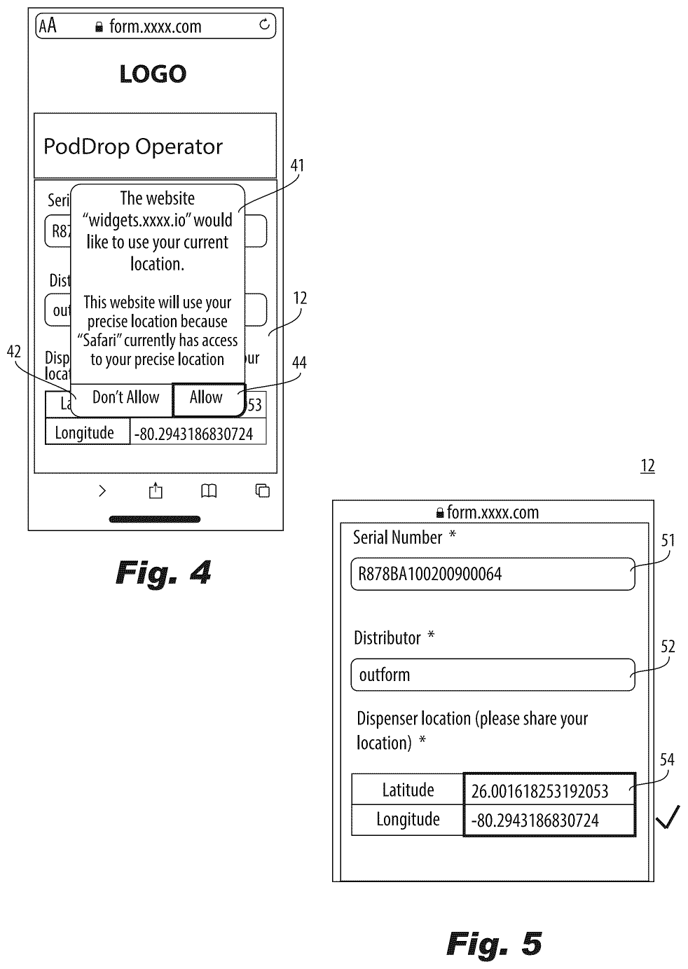

FIGS. 4 and 5 show the screens of interactive smart device screens that are being used to access and download information about status of the system and perform routine maintenance on the system. The status can include the fill level, the usage, the expectant life of the motors, and so on. FIG. 4 shows terminal 12 of a user being asked to share their location to ensure that the operator is actually on site and next to the kiosk being worked on. The terminal 12 screen shows an operator's name 41 or identifier at the top of the screen along with an “allow/don't allow” widgets 42/44 below asking for the precise location of the terminal 12 to be shared with a remote server. FIG. 5 shows a next step of a maintenance terminal 12, where the user inputs their personal identifier 51 and company identifier 52 are shown ready to be filled and a location has been shared in box 54.

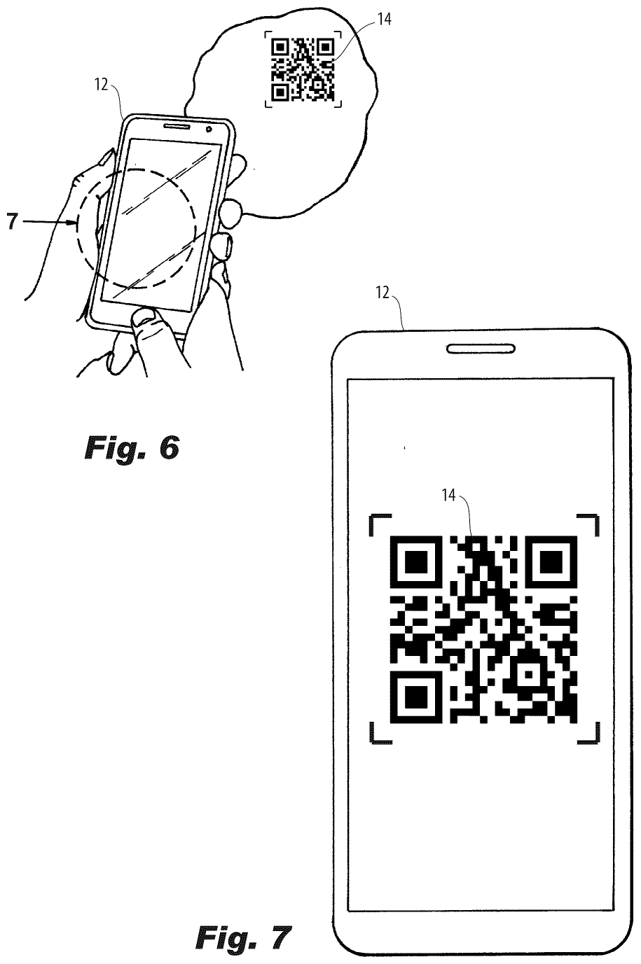

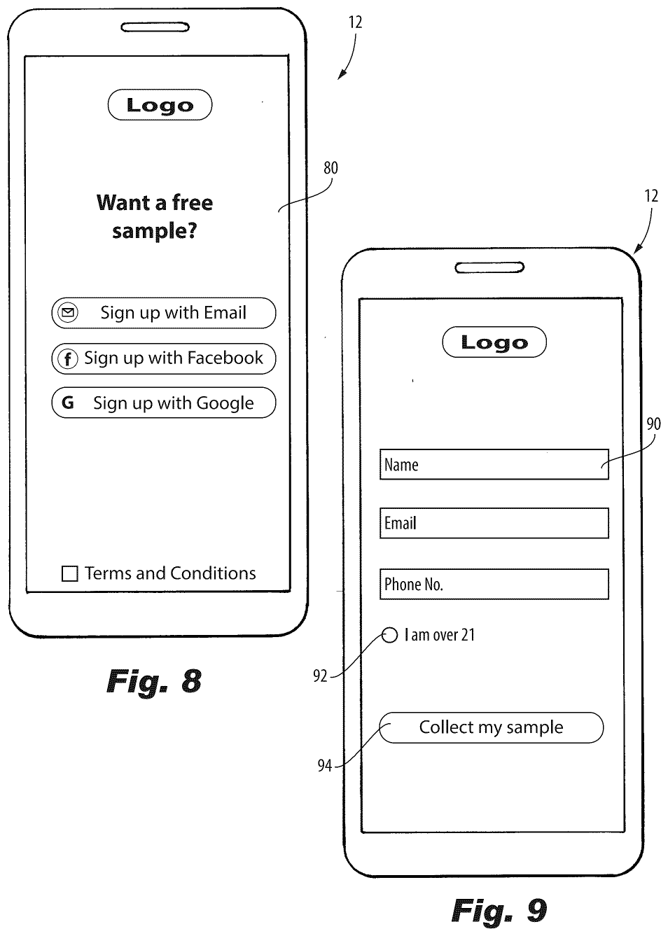

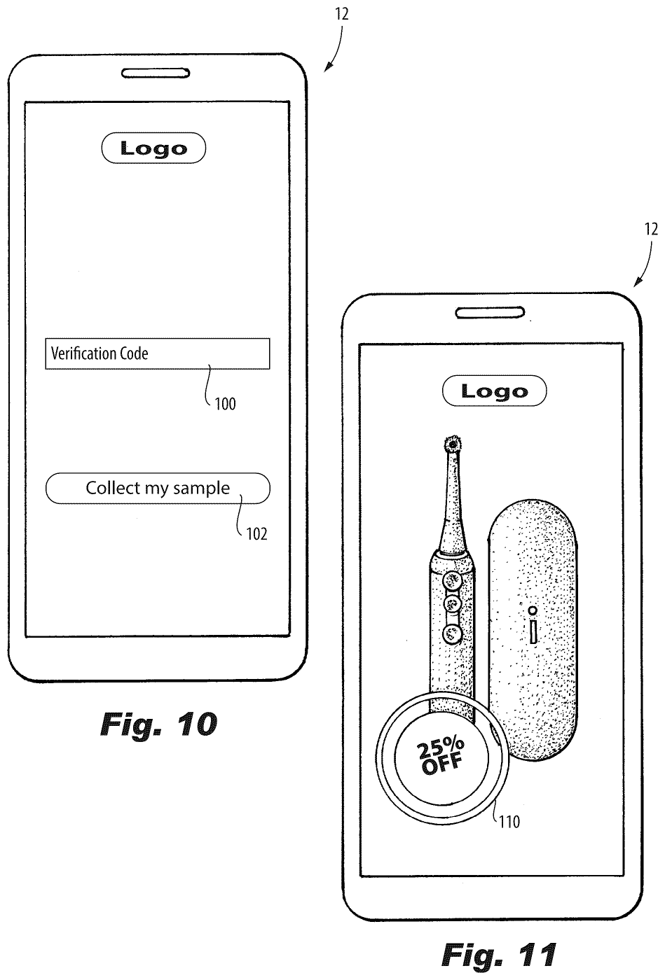

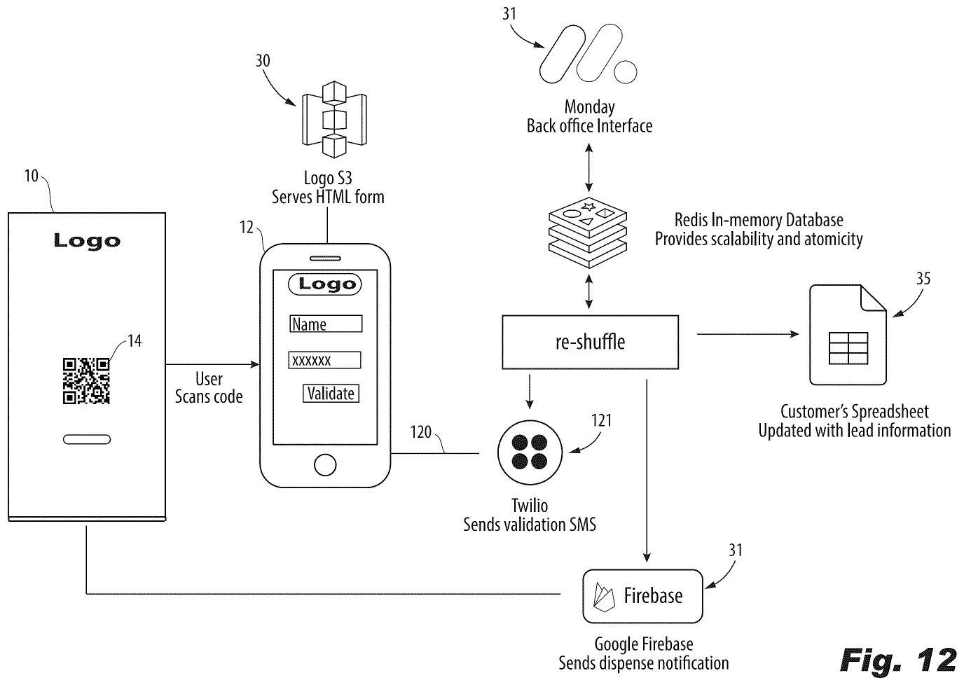

FIGS. 6 through 11 illustrate interactive smart device screens that enable a consumer to collect a product sample from the system 10 in a touchless manner using a mobile device or terminal 12, while FIG. 12 is a schematic diagram of the data flow interface for the system 10 of the subject invention. FIG. 6 shows the mobile device or terminal 12 being used to scan the code 14, located on the outside of the system 10. As the QR code is scanned, the mobile device's or terminal's 12 internal processors decode the embedded code of the QR code and direct the user to a website, app, or other landing page that is hosted by an external server, where the user's contact information can be input. FIG. 8 depicts the display of the mobile device or terminal 12 showing a self-identification process, where the user is prompted to use a pre-existing account 80 or profile on a secondary network such as Facebook, Google, or an existing e-mail address. FIG. 9 depicts the display of the mobile device or terminal 12 showing another self-identification process, where the user is prompted to input the user's name and contact info into boxes 90, along with an age verification button 92. Once registration has been completed, a user can hit the submit button 94. Once the information has been input and transferred to the system 10 server, a verification code is sent back to the contact the user had provided in the previous step, as depicted in FIG. 10. The verification code is then input into box 100 on the screen of the terminal 12, and the collect sample button 102, can be pressed. The button 102 activates the dispensing wheel and moves one pod to the access port. FIG. 11 depicts a mobile device or terminal 12, after the sample had been delivered, showing a promotion and information 110 about the product sample. Preferably, the system 10 is configured to collect information from and deliver information to the consumer, and it requires verification to prevent a user from collecting more than one pod or sample. Moreover, the dispensing of product samples is controlled by reference to one or more databases stored on a remote server.

FIG. 12 depicts the data flow interface for the system of the sample dispending system. After a user scans the QR code 14 and enters their contact details 120, that contact information is sent to a server 30 for validation. Once validated, server 30 sends a “dispense” command to a second server 31, but do not directly to the sample dispensing system 10. The system 10 listens for the “dispense” command 121 by monitoring the second server 31 server. This method helps ensure that a sample is dispensed even if the IP address or location of the kiosk changes. The contact information can also be stored by the third party, preferably one that supplies the samples on a spreadsheet or database 35.

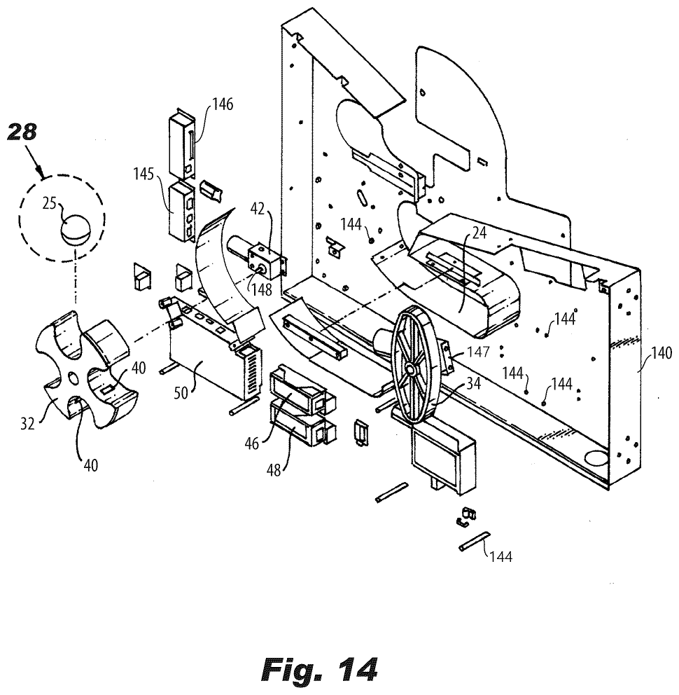

Referring now to FIGS. 13 and 14 the interior defined within the enclosure of the dispensing system 10 shown in FIG. 1, and with parts separated in FIG. 14 for ease of illustration. The system 10 includes a dispensing wheel 32 mounted for rotation adjacent the access port 16 and an oval or otherwise elliptically shaped agitator wheel 34 mounted for movement within the storage compartment 22 to agitate the spherical pods 25 within the storage compartment 22 so as to reduce friction between adjacent spherical pods 25 in the closely-packed assemblage and promote movement of pods from the storage compartment 22 towards the dispensing wheel 32. The depth of the storage compartment 22 is less than twice a diameter of the spherical pod, ensuring that the pods are always in-line and read to be received by the dispensing wheel 32. The sample dispensing system 10 further includes a first motor 42 for rotating the dispensing wheel 32 and a second motor 44 for rotating the agitator wheel 34. A ramped guide path 36 provides communication between the storage compartment 22 and the dispensing area 24, wherein the guide path 36 leads to the dispensing wheel 32. The dispensing wheel 32 is mounted for rotation in a clock-wise direction about an axis that extends perpendicular to the guide path 36. The dispensing wheel 32 has a generally circular configuration and includes a plurality of circumferentially spaced apart pockets 38, each for receiving a spherical pod 25 delivered from the ramped guide path 36. The dispensing wheel 32 has sensors 40 associated with the each of the plurality of circumferentially spaced apart pockets 38 for detecting reception of a spherical pod 25.

The elliptical agitator wheel 34 is mounted for rotation in a clock-wise direction and in a counter-clockwise direction. The agitator wheel 34 is turned on when the dispensing wheel sensors 40 expect a spherical pod 25 but do not contact it, which means there is a blockage. The agitator wheel 34 can turn in a variety of ways including partially clock-wise and then counter-clockwise or make full rotations in one direction or the other, until the spherical pods 25 are freed and dispensing wheel sensors 40 feel a pod 25 within the pocket 38.

A first motor controller 46 is provided in the enclosure for controlling the first motor 42 and a second motor controller 48 is provided in the enclosure for controlling the second motor 44. In addition, communication means 50 are provided in the enclosure for enabling a consumer to interact with the motor controllers 46, 48 in a touch-less manner, using a smart device by way of a QR code, to obtain a spherical pod 25 from the access port 16 to receive a product sample. The communication means 50 allows the system 10 to communicate with remote servers to validate a potential customer or user account. The communication means 50 can include a router 146 and hardwire receivers 145.

The mechanics of the system 10 described above are concealed within a housing 140. The housing 140 houses and provides a mounting and support means 144 for each of the motor controllers 46 and 48, the motors 42 and 44. The housing 140 further houses the axle 147 on which the agitator wheel 34 and the axle 148 on which the dispensing wheel 32 spins on.

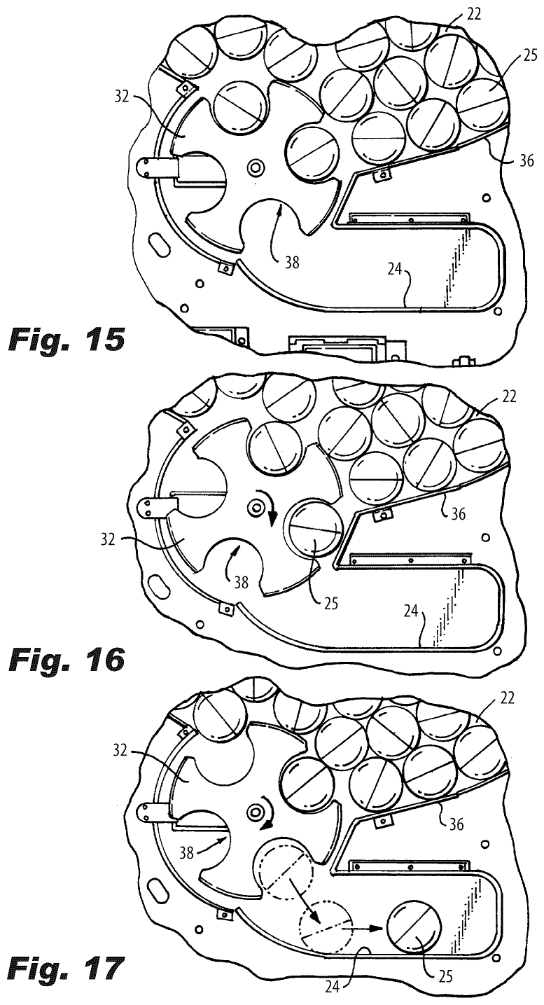

Referring to FIGS. 15 through 17, in use clockwise-rotational movement of the dispensing wheel 32 causes the transfer of a single spherical pod 25 from the storage compartment 22 to the access port 16 of the dispensing area 24. As discussed previously, the dispensing wheel 32 with pockets 38 sized to accommodate a single spherical pod 25, as pod 25 comes down ramp 36, the dispensing wheel 32 turns clockwise to transfer an individual pod 25 to the dispensing area 24.

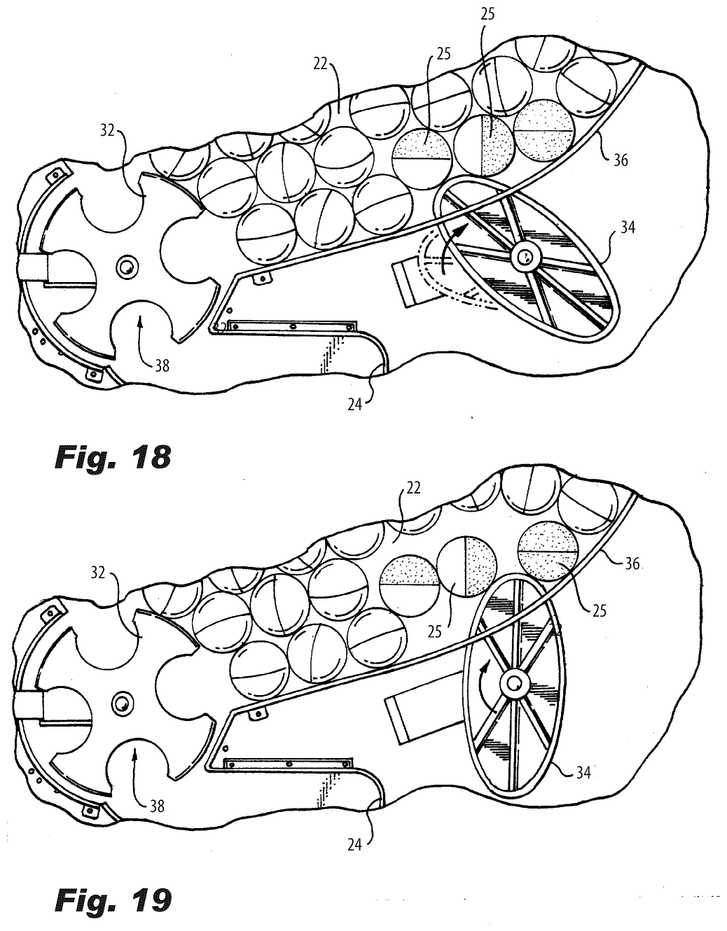

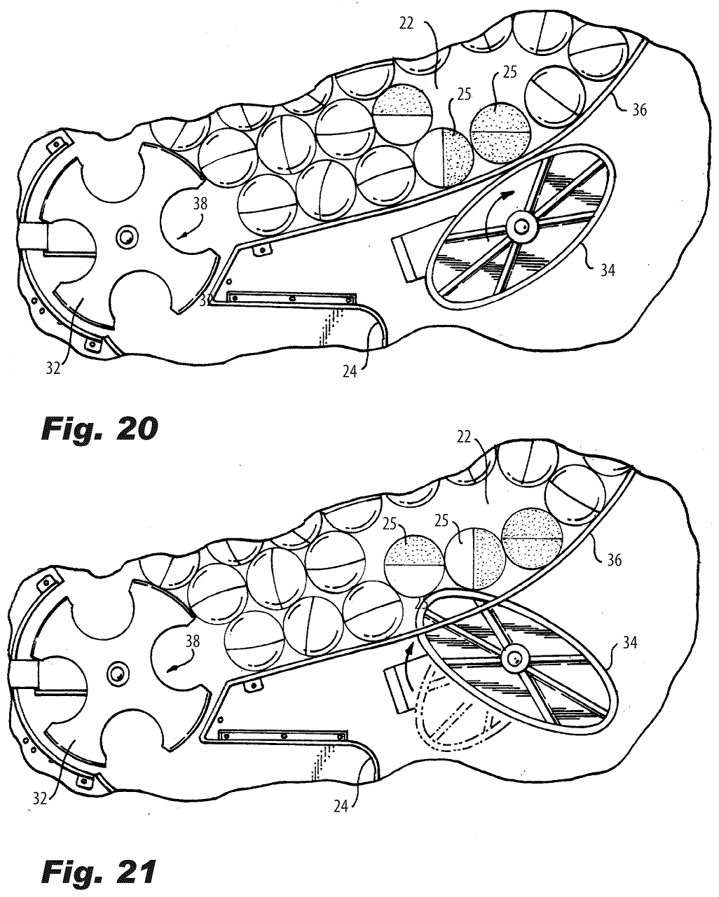

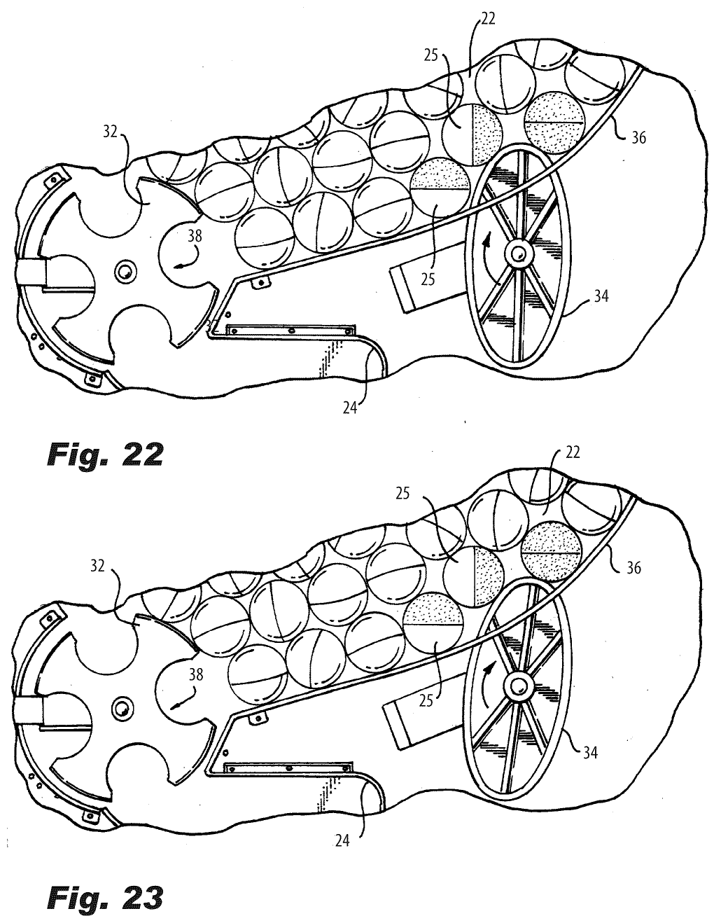

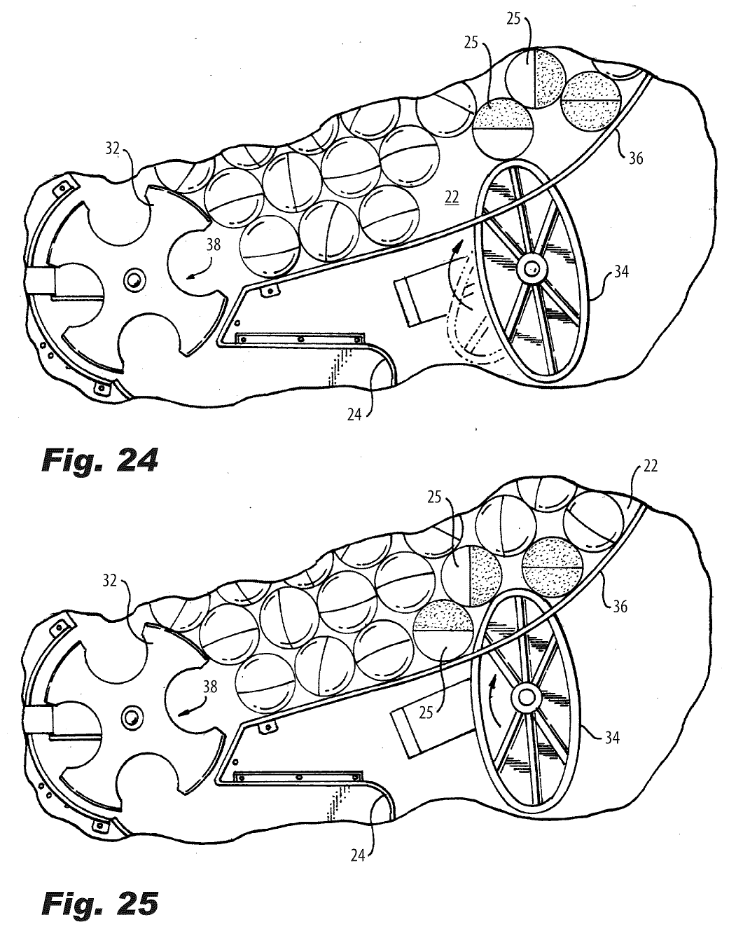

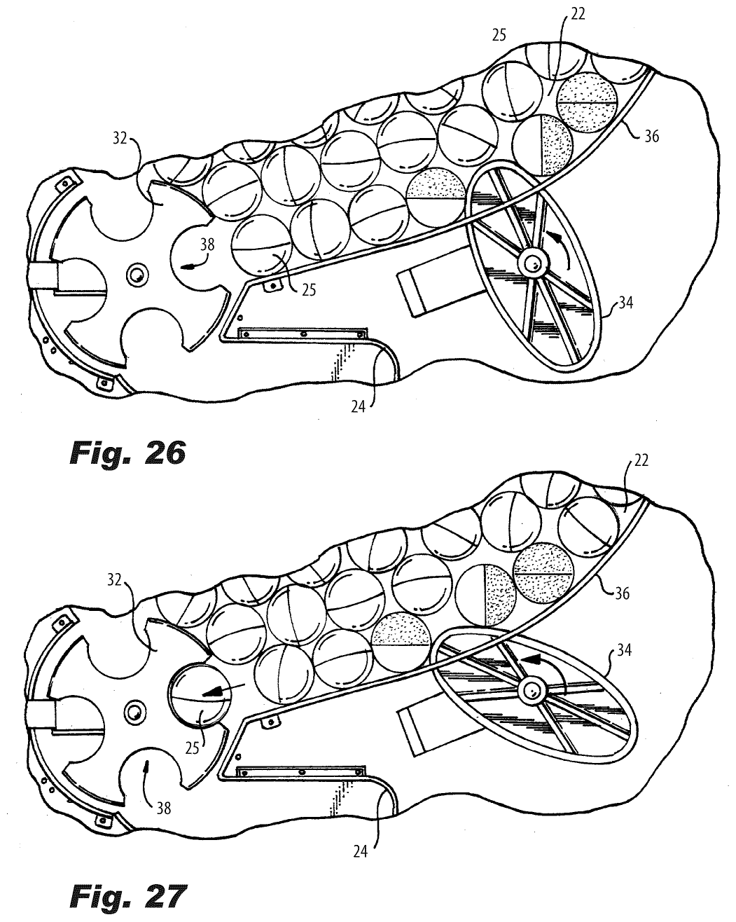

FIGS. 18 through 27 illustrate the clockwise and counter-clockwise movements of the agitator wheel 34, which is mounted partially within the storage compartment 22 and protrudes through ramp 36 to agitate the spherical pods 25 within the storage compartment 22. This reduces friction between adjacent spherical pods 25 in the closely-packed assemblage and promotes movement of pods 25 from the storage compartment 22 towards the dispensing wheel 32 by way of the ramped guide path 36. The agitator wheel 34 will turn until a spherical pod 25 is positioned within the pocket 38. The agitator can rotate any number of times in one direction, and then change direction and rotates a number of times in the reverse direction. This back-and-forth rotation will continue until a pod 25 is detected by a sensor 40 is a pocket 38 of the dispensing wheel 32. The agitator wheel 34 is turned on when the dispensing wheel sensors 40 expect a spherical pod 25 but do not contact it (as shown in FIG. 18-26, which means there is a blockage. Finally, in FIG. 27, a spherical pod 25 is freed and rolls down ramp 36 to pocket 38.

FIG. 28 is a perspective view of a two-piece spherical pod 25, separated into two hemi-spherical sections 25a, 25b to show a product sample 60 contained therein. Preferably, each pod 25 is made from a light-weight bio-degradable material. It is also considered that the pods can be of various shapes and sizes including angled and non-uniform shapes in order to better accommodate various shapes of samples 60, but allow for an internal cavity 56 for the sample 60 to sit inside.

Referring now to FIG. 29, there is illustrated an alternate embodiment of the dispensing system of the subject invention, designated generally by reference numeral 100, wherein products 113 associated with the samples dispensed by the system are displayed on shelves 123 below the sample access port 116.

While the subject disclosure has been shown and described with reference to preferred embodiments, those skilled in the art will readily appreciate that changes and/or modifications may be made thereto without departing from the scope of the subject disclosure.

1-20. (canceled)

21. A consumer engagement and management system, comprising:
a) a product dispenser configured to hold, and to dispense a sample product in response to a request from a consumer, the product dispenser including a dispensing area having an access port accessible by the consumer to retrieve the dispensed product sample;
b) an interactive display included on the product dispenser for enabling the consumer to interact product dispenser in a contactless manner, the interactive display comprising a scannable code by a mobile phone of the consumer to initiate the request; and
a control module configured to, upon the mobile phone scanning the scannable code:
automatically receive a telephone number of the mobile phone scanning the scannable;
establish a network connection between the mobile phone and the product dispenser to verify the consumer making the request is entitled to receive the sample product by comparing the telephone number to a database of previously collected telephone numbers; and
request additional personal contact information from the consumer to associate with the telephone number; and
wherein the control module is further adapted and configured to:
cause the product dispenser to release only one sample product from the product dispenser solely upon verification that the consumer is entitled to receive the sample product; and
cause the product dispenser to prevent release of a second sample product to the same consumer,
wherein the consumer does not physically touch the product dispenser in order to dispense the sample product.

22. The system of claim 21, wherein the additional personal contact information from the consumer includes a consumer name and a consumer email address.

23. The system of claim 22, wherein upon receipt of the mobile telephone number, the consumer name, and the consumer email address, the control module is configured to determine whether the telephone number, the consumer name, and the consumer email address are already stored in the database to determine whether the consumer is entitled to receive the product sample, and wherein the control module is configured to determine whether the consumer email address is a valid email address such that when a combination of one or more of the telephone number, the consumer name and the consumer email address is already in the database or when the consumer email address is not a valid email address, the control module determines the consumer is not entitled to receive the product sample and the control module is configured to cause the product dispenser to prevent release of the sample product to the consumer.

24. The system of claim 21, wherein:
the additional personal contact information of the consumer is received via a first web page rendered on the mobile phone of the consumer; and
a verification code provided to the consumer is received by the control module via a second web page rendered on the personal mobile device of the consumer.

25. The system of claim 21, wherein:
the additional personal contact information of the consumer is a consumer's pre-existing account on a secondary network; and
the control module is configured to verify the consumer's entitlement to receive the product sample by prompting the consumer to log in to the pre-existing account on a webpage rendered on the consumer's mobile phone.

26. The system of claim 21, wherein within the product dispenser, each sample product of the plurality of sample products is held within a respective spherical pod.

27. The system of claim 26, wherein the spherical pods are uniform and wherein the respective sample products within the spherical pods are not uniform.

28. The system of claim 21, further comprising, a product display for displaying one or more full size products associated with the sample product, wherein the product dispenser is operatively connected to the product display.

29. The system of claim 28, wherein the product display includes a plurality of shelves, and wherein the product dispenser is operatively connected to the product display above the plurality of shelves.

30. The system of claim 21, wherein within the product dispenser, each sample product of the plurality of sample products is held within a respective spherical pod,
wherein the product dispenser further comprises:
a storage compartment for holding the plurality of spherical pods in a closely-packed assemblage;
a dispensing area communicating with the storage compartment and including an access port accessible by a consumer to obtain the dispensed single spherical pod; and
a dispensing wheel mounted for rotation at least partially within the storage compartment and at least partially within the dispensing area for transferring the single spherical pod from the storage compartment to the access port, wherein the dispensing wheel includes sensing means for detecting the reception of a spherical pod thereby.

31. The system of claim 30, wherein the product dispenser further comprises:
an agitator mounted for rotational movement within the storage compartment to agitate the spherical pods within the storage compartment when a blockage is detected so as to reduce friction between adjacent spherical pods in the closely-packed assemblage and promote movement of spherical pods from the storage compartment towards the dispensing wheel,
wherein the agitator is rotated when the reception of the single spherical pod by the dispensing wheel is expected but undetected by the sensing means, and wherein the agitator is rotated until the reception of the single spherical pod by the dispensing wheel is detected by the sensing means.

32. The system of claim 31, further comprising: a first motor for rotating the dispensing wheel and a second motor for rotating the agitator.

33. The system of claim 32, wherein the control module is configured to control the first motor and the second motor based on the determination of whether the consumer is entitled to receive the product sample.

34. A method of managing and tracking consumer engagement with respect to a product, using a sample product dispensed from a product dispenser, the method comprising the steps of:
a) receiving a request from a consumer to obtain the sample product from the product dispenser;
b) prompting the consumer to provide personally-identifying information via a personal mobile device of the consumer;
c) receiving the personally-identifying information, storing the personally-identifying information in a database, and comparing the personally-identifying information to information stored in the database;
d) determining whether the consumer is entitled to receive the product sample based on the comparison; and
e) dispensing a single sample product to the consumer solely upon verification that the consumer is entitled to receive the sample product,
wherein the consumer does not physically touch the product dispenser in order to dispense the sample product.

35. The method of claim 34, wherein the personally-identifying information from the consumer includes a consumer phone number, a consumer name, and a consumer email address.

36. The system of claim 35, wherein upon receipt of the consumer phone number, the consumer name, and the consumer email address, the method further includes:
f) determining whether the consumer phone number, the consumer name, and the consumer email address are already stored in the database to determine whether the consumer is entitled to receive the product sample, and
g) determining whether the consumer email address is a valid email address;
wherein the determining step d) further includes;
i) determining whether a combination of one or more of the consumer phone number, the consumer name and the consumer email address is already in the database or whether the consumer email address is not a valid email address; and
ii) determining the consumer is not entitled to receive the product sample when:
the consumer number, the consumer name and the consumer email address is already in the database; or
the consumer email address is not a valid email address.

37. The method of claim 34, wherein:
the personally-identifying information is received via a first web page rendered on the mobile phone of the consumer, and the method further comprising:
providing a verification code to the consumer via a second web page rendered on the personal mobile device of the consumer.

38. The method of claim 34, wherein:
the personally-identifying information is a consumer's pre-existing account on a secondary network, and the method further comprising:
verifying the consumer's entitlement to receive the sample product by prompting the consumer to log in to the consumer's pre-existing account on a webpage rendered on the consumer's mobile phone.

39. The method of claim 34, wherein within the product dispenser, each sample product of the plurality of sample products is held within a respective spherical pod, wherein the spherical pods are uniform and wherein the respective sample products within the spherical pods are not uniform.

40. The method of claim 39, wherein the dispensing step further include:
s dispensing one and only one spherical pod to the consumer upon verification of the consumer's entitlement to receive the sample product, and wherein the method further includes:
preventing dispensing of additional spherical pods to the same consumer.
